(19) United States
(12) Patent Application Publication
(10) Pub. No.: US 2024/0110070 A1
(43) Pub. Date: Apr. 4, 2024

(54) PHOTORESIN FORMULATIONS AND USE THEREOF FOR VOLUMETRIC ADDITIVE MANUFACTURING

(71) Applicant: National Research Council of Canada, Ottawa (CA)

(72) Inventors: Yujie ZHANG, Ottawa (CA); Antony ORTH, Ottawa (CA); Daniel WEBBER, Kanata (CA); Kathleen SAMPSON, Ottawa (CA); Thomas LACELLE, Ottawa (CA); Chantal PAQUET, Ottawa (CA); Hendrick de HAAN, Oshawa (CA)

(21) Appl. No.: 18/102,936

(22) Filed: Jan. 30, 2023

Related U.S. Application Data
(60) Provisional application No. 63/408,239, filed on Sep. 20, 2022.

(51) Int. Cl. C09D 11/101; B33Y 10/00; B33Y 50/02; B33Y 70/10; B33Y 80/00; C08L 33/08; C09D 4/06

(52) U.S. Cl. CPC C09D 11/101; B33Y 10/00; B33Y 50/02; B33Y 70/10; B33Y 80/00; C08L 33/08; C09D 4/06

(57) ABSTRACT

A photoresin formulation for volumetric additive manufacturing contains a photo-curable mixture of: a monomer (e.g., an acrylate-based monomer); a photoinitiator; a polymerization inhibitor (e.g., molecular oxygen (O₂)); and, a reducing agent reactive with a free radical species (e.g., a peroxyl radical) formed from the polymerization inhibitor. The reducing agent permits faster printing of objects from the photoresin formulation in a volumetric additive manufacturing process to produce 3D objects of high fidelity.

### CROSS-REFERENCE TO RELATED APPLICATIONS

This application claims the benefit of U.S. Provisional Patent Application 63/408,239 filed Sep. 20, 2022, the entire contents of which is herein incorporated by reference.

### FIELD

This application relates to three-dimensional (3D) printing, in particular to volumetric additive manufacturing (VAM) (e.g., tomographic 3D printing) and photoresin formulations therefor.

### BACKGROUND

Volumetric additive manufacturing (VAM) (e.g., tomographic 3D printing, computed axial lithography (CAL) and the like), is an emerging light-based 3D printing technology that uses photoresin formulations to fabricate complex 3D objects while reducing or eliminating the need for support structures. Light images, obtained through the reverse of computed tomography (CT), are projected towards a container, preferably a rotating container, filled with a photoresin formulation. Only once the photoresin formulation locally absorbs light doses exceeding a ‘gelation threshold’ does the photoresin formulation solidify to form the desired 3D object.

Nevertheless, there remains a need for photoresin formulations that provide a better balance between reaction speed and sedimentation inhibition during VAM to produce 3D objects having high fidelity and good resolution.

### SUMMARY

A photoresin formulation for volumetric additive manufacturing contains a photo-curable mixture of: a monomer; a photoinitiator; a polymerization inhibitor; and, a reducing agent reactive with a free radical species formed from the polymerization inhibitor.

A photoresin formulation for volumetric additive manufacturing comprises a photo-curable mixture of: an acrylate-based monomer; a photoinitiator; a polymerization inhibitor comprising molecular oxygen (O₂); and, a reducing agent reactive with a peroxyl radical formed from the polymerization inhibitor.

A volumetric additive manufacturing process for producing a printed object comprises projecting patterned light for a duration of time through a print volume of a photoresin formulation as defined above.

A printed object is produced by the process as define above.

In some embodiments, the reducing agent comprises an amine, a thiol, a silane, a stannane, a phosphine, a phosphite, phosphinite, a phosphonate, an aldehyde, a borane or any mixture thereof.

In some embodiments, the reducing agent comprises 2-30 carbon atoms.

In some embodiments, the reducing agent comprises an organophosphorus compound.

In some embodiments, the reducing agent comprises N-methyldiethanolamine, N,N-dimethylethanolamine, 2-(N-methyl-N-phenylamino)-1-phenylethanol, dimethylamino ethylacrylate, alkyldimethylamine, N,N-bis[3-(methylamino)propyl]methylamine, N,N-dimethylaminobenzoate, N,N-dimethyl(2-morpholinoethyl)amine, 1,4-diazabicyclo[2.2.2]octane, tribenzyl amine, trimethylamine, tributylamine, pyrrolidine, ethylamine, piperazine, piperidine, 2-mercaptoethanol, pentaerythritol tetrakis(mercaptopropionate), 1,6-hexanedithiol, ethylene glycol bis(3-mercaptopropionate), mercaptopropylmethylsiloxane, mercaptobenzoxazole, mercaptobenzamidazole, mercaptobenzothiazole, trimethylolpropane tris(3-mercaptopropionate), tetrafluoroborate, dimethylamine-borane complex, dimethylaminopyridine borane complex, tert-butyl amine borane complex, morpholine borane complex, N-heterocyclic carbene borane complex, tris(trimethylsilyl)silane, triphenyl silane, ethyl diphenylphosphinite, methyl diphenylphosphinite, diethyl phosphonate, dioleyl hydrogen phosphite, dimethyl trimethylsilyl phosphite, tricyclohexylphosphine tributylphosphine triphenylphosphine, trimesitylphosphine, tris(2,4,6-trimethoxyphenyl)phosphine, triphenylphosphite, trioctyl phosphine, tetraphenyl dipropyleneglycol diphosphite, poly(dipropyleneglycol) phenyl phosphite, bisphenol A phosphite, tris(tridecyl) phosphite, triisopropyl phosphite, 3,9-bis(octadecyloxy)-2,4,8,10-tetraoxa-3,9-diphosphaspiro[5.5]undecane, tri-n-butyl stannane or any mixture thereof.

In some embodiments, the reducing agent comprises N-methyldiethanolamine, ethyl diphenylphosphinite or triphenylphosphine.

In some embodiments, the photoinitiator comprises: camphorquinone; ethyl 4-dimethylaminobenzoate; ethyl (2,4,6-trimethylbenzoyl) phenylphosphinate (TPO-L); 2-benzyl-2-dimethylamino-1-(4-morpholinophenyl)-butanone-1; 2-dimethylamino-2-(4-methyl-benzyl)-1-(4-morpholin-4-yl-phenyl)-butan-1-one; thioxanthone anthracene; diphenyl (2,4,6-trimethylbenzoyl) phosphine oxide; phenylbis(2,4,6-trimethylbenzoyl) phosphine oxide; sodium persulfate; 2-hydroxy-4′-(2-hydroxyethoxy)-2-methylpropiophenone or, any mixture thereof.

In some embodiments, the photoinitiator is present in the formulation in a concentration of 0.01-100 mM and the reducing agent is present in the formulation in a concentration of 1-500 mM.

In some embodiments, the monomer comprises a monoacrylate, diacrylate, a triacrylate, a tetraacrylate, a pentaacrylate, a monomethacrylate, a dimethacrylate, a trimethacrylate, a tetramethacrylate, a pentamethacrylate or any mixture thereof.

In some embodiments, the monomer comprises bisphenol A glycerolate (1 glycerol/phenol) diacrylate, an aliphatic urethane diacrylate, di-pentaerythritol pentaacrylate, a diurethane dimethacrylate (DUDMA), bisphenol A ethoxylate dimethacrylate, triethylene glycol dimethacrylate, bisphenol A-glycidyl dimethacrylate (BisGMA), gelatin methacrylate, poly(ethylene glycol) diacrylate, hexyl acrylate, 2-[[(butylamino)carbonyl]oxy]ethyl acrylate, trimethylolpropane triacrylate, ethoxylated bisphenol A dimethacrylate, tricyclodecane dimethanol diacrylate, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, or pentaerythritol tetraacrylate, 1,4-butanediol diacrylate or any mixture thereof.

In some embodiments, the photo-curable mixture further comprises an organic solvent.

In some embodiments, the organic solvent comprises toluene, heptane, n-octane, tetrahydrofuran, ethanol, isopropanol, or any mixture thereof.

In some embodiments, the photo-curable mixture has a viscosity in a range of 50-100,000 cP.

In some embodiments, a pattern of the patterned light is calculated using tomographic imaging such that a shape of a light dose distribution matches the object to be printed.

In some embodiments, the print volume of the photoresin formulation is rotated during projection of the patterned light.

In some embodiments, the duration of time to produce the printed object is reduced by at least 50-99% in comparison to a duration of time to produce an object from a photoresin formulation lacking the reducing agent but which is otherwise the same as the photoresin formulation as defined in any one of claims 1 to 13.

In some embodiments, wherein the patterned light has an average pixel light intensity in a range of 0.1-50 mW/cm².

In some embodiments, wherein the minimum printable box dimension is 14 mm or less.

The reducing agent reduces the amount of photoinitiator needed to print and reduces the polymerization delay time while permitting the polymerization to be non-linear with light dose. Overall, the reducing agent permits faster printing of objects from the photoresin formulation in a volumetric additive manufacturing process in comparison to printing objects from a photoresin formulation lacking the reducing agent but which is otherwise the same as a photoresin formulation as defined above. Further, the photoresin formulations can provide improved sedimentation inhibition during VAM and produce 3D objects at a broad range of wavelengths, the 3D objects having good resolution and much higher print fidelity than objects printed without the presence of the reducing agent. Furthermore, the same light dose can be used to print small and large features of an object with less difference in print times resulting in high print fidelity. In general, the photoresin formulations offer one or more of the following advantages over existing photoresin formulations: faster printing speed, higher print resolution, smoother surfaces on the printed object, printing of lower viscosity photoresins, printing larger objects, easier preparation and post processing, tunable material properties and the ability to produce biocompatible parts. Such improved properties arise from the ability to more finely tune the viscosity and reactivity of the multicomponent photoresin formulations.

The photoresin formulations are especially useful in additive manufacturing techniques but can be used in 3D printing in general. The photoresin formulations enable the fabrication of 3D printed polymer parts with high resolution requirements and unmatched design freedom. Such parts can be used, for example, as specialty optics (e.g., micro-optics, free-form optics and fiber optics), as lenses or antennas for RF telecommunications, as implants (e.g., ear implants, dental implants and orthopedic implants), as artificial tissues and organs, in microfluidics, in metal-polymer or ceramic-polymer hybrid structures, as metamaterials, and the like.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a print design of a cylindrical stack used to determine the effect of photoresin formulation on printing time required for various feature sizes, the stack having cylinders of 10 mm diameter and heights ranging from 0.06 mm to 0.60 mm.

FIG. 2 depicts a graph of printing time (s) vs. viscosity (cP) for various photoresin formulations comprising acrylate-based monomers.

FIG. 3 depicts a graph of printing time (s) vs. cylinder height (mm) showing the effect of viscosity of various photoresin formulations on print fidelity.

FIG. 4 depicts a photo-rheometry graph illustrating how cross-over time and delay time may be characterized in the photopolymerization of acrylate-based photoresin formulations.

FIG. 5 depicts a graph of delay time (s) and cross-over time (s) as a function of N-methyldiethanolamine concentration (mM) illustrating the correlation between delay time and cross-over time in the photopolymerization of an acrylate-based (DUDMA) photoresin formulation and illustrating the substantial decrease in delay time when N-methyldiethanolamine is used as a reducing agent in the photoresin formulation.

FIG. 6 depicts graphs of delay time (s) and cross-over time (s) as a function of N-methyldiethanolamine concentration (mM) in the photopolymerization of acrylate-based (DUDMA) photoresin formulations containing various concentrations of TPO-L photoinitiator.

FIG. 7 depicts a graph of printing time (s) vs. cylinder height (mm) for cylinders of various height printed from a DUDMA photoresin formulation containing 1.75 mM TPO-L photoinitiator and either no reducing agent or 466 mM of N-methyldiethanolamine as a reducing agent.

FIG. 8A depicts a graph of delay time (s) as a function of N-methyldiethanolamine concentration (mM) (MDEA) comparing D8P2 formulations to DUDMA formulations that contained the same concentrations of TPO-L and N-methyldiethanolamine.

FIG. 8B shows a graph of crossover time (s) as a function of N-methyldiethanolamine concentration (mM) (MDEA), comparing D8P2 formulations to DUDMA formulations that contained the same concentrations of TPO-L and N-methyldiethanolamine.

FIG. 9A depicts a graph of delay time (s) as a function of N-methyldiethanolamine and N,N-dimethylethanolamine concentration (mM) for DUDMA formulations that contained the same concentrations of TPO-L.

FIG. 9B depicts a graph of crossover time (s) as a function of 10 mm diameter and heights ranging from 0.06 mm to 0.60 mm and N,N-dimethylethanolamine concentration (mM) for DUDMA formulations that contained the same concentrations of TPO-L.

FIG. 10A depicts graphs of gelation time (s) as a function of disc thickness (mm) (left) and gelation time (s) as a function of disc thickness (mm) normalized (right), where the upper curve is for discs printed from D8P2 without reducing agent and the lower curve is for discs printed from D8P2 with N,N-dimethylethanolamine as a reducing agent.

FIG. 10B depicts images of a digital model for a set screw alongside optical microscope images of the set screw printed with micro-VAM from a photoresin formulation containing no reducing agent (D8P2) and from a photoresin formulation containing N-methyldiethanolamine reducing agent (D8P2+Amine).

FIG. 10C depicts optical images of plano-convex lenses printed with micro-VAM using the D8P2 photoresin formulation with and without N-methyldiethanolamine reducing agent.

FIG. 11 depicts a digital design model of a compound lens and microscope images of top, side and bottom views in descending order of the compound lens printed with micro-VAM in D8P2 and printed with micro-VAM in D8P2+N-methyldiethanolamine.

### DETAILED DESCRIPTION

VAM is significantly different from other vat 3D printing techniques and so are the photoresin requirements. Factors to consider when developing a photoresin appropriate for VAM include photoresin flow, light penetration depth, sedimentation and diffusion of reactive species. Since the inception of VAM printing, no thorough studies have been completed to illuminate what makes a good photoresin for VAM. In general, photoresin formulations may be designed to meet a number of conditions to function with VAM. Examples of these conditions may include: 1) allowing sufficient light to penetrate through the volume of photoresin to be printed (i.e., the print volume, whereby the print volume is the volume of photoresin that is to be illuminated with light and polymerized into the object) to ensure polymerization can be initiated in all regions of the print volume; 2) having relatively high viscosity to minimize sedimentation of solidified photoresin and to prevent flow of photoresin that can lead to undesirable printing artefacts; 3) having an underlying mechanism that causes the polymerization to be non-linear with light dose, and the like. This threshold response may be achieved by using a polymerization inhibitor that inhibits polymerization until the inhibiting species is depleted. For example, one approach is the use of molecular oxygen (O₂) as a photoinhibitor as oxygen inhibits the polymerization of acrylates until most or all the oxygen is consumed through the reaction with photoinitiator.

The photoresin formulation conditions for VAM significantly limit the selection of possible precursors, as there are not many high viscosity acrylates available, and as a result, limit the material properties that can be achieved, which in turn limit the potential applications for VAM. Currently acrylate-based photoresin formulations with high viscosity (ranging from about 10,000 to about 90,000 cP) are used in VAM, especially tomographic printing, and there are only a very limited number of photoresin formulations that have been tested and applied in this technique. When high viscosity photoresins (e.g., acrylate precursors) are used, they are often slow to print due to the constrained movement of molecules, show poor printing fidelity and are difficult to process and manipulate before and after printing. Thus, photoresins typically used heretofore for VAM have had higher viscosity (about 10,000 to 90,000 cP), poor print quality, slower printing speed, difficulties in post-processing and difficulties printing different feature sizes all at once. A possible solution that would allow lower viscosity resins to be used with VAM without introducing the printing problems associated with low viscosity photresins is to use photoresin formulations that polymerize quickly.

### Formulation:

The photoresin formulation comprises a photopolymerizable monomer. Any such polymerizable monomer may be utilized. In some embodiments, the monomer is an acylate-based monomer. In some embodiments, the acrylate-based monomer comprises an acrylate or methacrylate, especially a multifunctional acrylate or methacrylate. In some embodiment, the monomer comprises a monoacrylate, a diacrylate, a triacrylate, a tetraacrylate, a pentaacrylate, a monomethacrylate, a dimethacrylate, a trimethacrylate, a tetramethacrylate, a pentamethacrylate or any mixture thereof. Some examples of acrylate-based monomers are bisphenol A glycerolate (1 glycerol/phenol) diacrylate, an aliphatic urethane diacrylate, di-pentaerythritol pentaacrylate, a diurethane dimethacrylate, bisphenol A ethoxylate dimethacrylate, triethylene glycol dimethacrylate, bisphenol A-glycidyl dimethacrylate, gelatin methacrylate or any mixture thereof. In some embodiments, the monomer is in the form of a photocurable monomer resin. In the present formulations, the monomer resin can have high or low viscosity. A high viscosity monomer resin has a viscosity in a range of about 2,000 cP to about 1,000,000 cP. A low viscosity monomer resin has a viscosity less than about 2,000 cP, for example 5-1,000 cP. Mixtures of monomer resins may be used. In some embodiments, high viscosity acrylate/methacrylate monomer resins include diurethane dimethacrylates (DUDMA, about 8,000-10,000 cP at 25° C.), bisphenol A-glycidyl dimethacrylate (BisGMA, about 680,000 cP at 25° C.), bisphenol A glycerolate (1 glycerol/phenol) diacrylate (about 2,000-4,000 cP at 65° C.), X991 0000 (urethane diacrylate from ESSTECH, Inc., about 17,600 cP at 25° C.), X891 0000 (urethane dimethacrylate from ESSTECH, Inc., about 230,000 cP at 25° C.), X930 0000 (urethane dimethacrylate from ESSTECH, Inc., about 816,000 cP at 25° C.), an Ebecryl urethane acrylate (from Allnex), SR399 (di-pentaerythritol pentaacrylate from Sartomer, about 13,600 cP at 25° C.), CN 9033 (an aliphatic urethane acrylate oligomer from Sartomer, about 9,300 cP at 60° C.) and CN 1969 (a urethane methacrylate from Sartomer, about 28,000 cP at 60° C.). In some embodiments, low viscosity acrylate/methacrylate monomer resins include poly(ethylene glycol) diacrylate, hexyl acrylate, 2-[[(butylamino)carbonyl]oxy]ethyl acrylate, trimethylolpropane triacrylate, ethoxylated bisphenol A dimethacrylate, tricyclodecane dimethanol diacrylate, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate and pentaerythritol tetraacrylate and 1,4-butanediol diacrylate. Different monomer resin mixtures may be utilized to tailor the viscosity and/or reactivity of the photoresin formulation.

The nature of the photoinitiator depends to some extent on the nature of the monomer. Suitable photoinitiators, especially for acrylate-based monomers, include, for example: camphorquinone (CQ, at wavelength of 455 nm); ethyl 4-dimethylaminobenzoate (EDAB, at wavelength of 455 nm); ethyl (2,4,6-trimethylbenzoyl) phenylphosphinate (TPO-L, at wavelength of 405 nm); 2-benzyl-2-dimethylamino-1-(4-morpholinophenyl)-butanone-1 (OMNIRAD™ 369, IGM RESINS); 2-dimethylamino-2-(4-methyl-benzyl)-1-(4-morpholin-4-yl-phenyl)-butan-1-one (OMNIRAD™ 379, IGM RESINS); thioxanthone anthracene; diphenyl (2,4,6-trimethylbenzoyl) phosphine oxide; phenylbis(2,4,6-trimethylbenzoyl)phosphine oxide; sodium persulfate; 2-hydroxy-4′-(2-hydroxyethoxy)-2-methylpropiophenone; or, any mixture thereof.

In some embodiments, the photoinitiator is present in the photoresin formulation in a concentration in a range of about 0.01-100 mM, the desired concentration being somewhat dependent on light penetration depth volume. For example, a concentration range of 0.3-5 mM is desirable when the light penetration depth volume is 2 cm or less. The presence of the reducing agent permits the use of less photoinitiator to achieve fast print times, the use of less photoinitiator being beneficial for increasing light penetration depth into the print volume ensuring that polymerization can be initiated in all regions of the print volume substantially at the same time and a larger print volume can be used.

The polymerization inhibitor may comprise any molecule that interacts with the photoinitiator to form a free radical species. In the case of acrylate-based monomers, the polymerization inhibitor is preferably molecular oxygen (O₂), which may be added to the photoresin formulation but does not need to be added if O₂ is generally already present in the photocurable monomer resin, for example in acrylate-based photocurable monomer resins. The presence of polymerization inhibitor in the photoresin formulation causes a delay in photoinitiation of the polymerization reaction due to the photoinitiator reacting with the polymerization inhibitor to form the free radical species therefrom (e.g., peroxyl radicals). For many photocurable monomer resins, the polymerization inhibitor may be present in an amount of about 0.1×10⁻³ to 5×10⁻³ mol/L.

The reducing agent may be any molecule that reacts with the free radical species formed from the polymerization inhibitor. The use of the reducing agent permits adjusting the reactivity of the photoresin formulation. The reducing agent preferably comprises an amine, a thiol, a silane, a stannane, a phosphine, a phosphite, phosphinite, a phosphonate, an aldehyde, a borane or any mixture thereof. The reducing agent preferably comprises an organic compound having 2-30 carbon atoms, more preferably 5-25 carbon atoms. In some embodiments, the reducing agent is an organophosphorus compound. Some examples of reducing agent include, for example, N-methyldiethanolamine, N,N-dimethylethanolamine, 2-(N-methyl-N-phenylamino)-1-phenylethanol, dimethylamino ethylacrylate, alkyldimethylamine, N,N-bis[3-(methylamino)propyl]methylamine, N,N-dimethylaminobenzoate, N,N-dimethyl(2-morpholinoethyl)amine, 1,4-diazabicyclo[2.2.2]octane, tribenzyl amine, trimethylamine, tributylamine, pyrrolidine, ethylamine, piperazine, piperidine, 2-mercaptoethanol, pentaerythritol tetrakis(mercaptopropionate), 1,6-hexanedithiol, ethylene glycol bis(3-mercaptopropionate), mercaptopropylmethylsiloxane, mercaptobenzoxazole, mercaptobenzamidazole, mercaptobenzothiazole, trimethylolpropane tris(3-mercaptopropionate), tetrafluoroborate, dimethylamine-borane complex, dimethylaminopyridine borane complex, tert-butyl amine borane complex, morpholine borane complex, N-heterocyclic carbene borane complex, tris(trimethylsilyl)silane, triphenyl silane, ethyl diphenylphosphinite, methyl diphenylphosphinite, diethyl phosphonate, dioleyl hydrogen phosphite, dimethyl trimethylsilyl phosphite, tricyclohexylphosphine tributylphosphine triphenylphosphine, trimesitylphosphine, tris(2,4,6-trimethoxyphenyl)phosphine, triphenylphosphite, trioctyl phosphine, tetraphenyl dipropyleneglycol diphosphite, poly(dipropyleneglycol) phenyl phosphite, bisphenol A phosphite, tris(tridecyl) phosphite, triisopropyl phosphite, 3,9-bis(octadecyloxy)-2,4,8,10-tetraoxa-3,9-diphosphaspiro[5.5]undecane, tri-n-butyl stannane or any mixture thereof.

In some embodiments, the reducing agent is present in the photoresin formulation in a concentration in a range of about 1-1000 mM, in other embodiments in a range of about 1-500 mM, and in yet other embodiments in a range of 1-300 mM. The desired concentration of reducing agent is somewhat dependent on the type of reducing agent and the concentration of the photoinitiator in that more reducing agent may be required when the concentration of the photoinitiator is at the lower end of the range. For example, when less than about 0.5 mM of the photoinitiator is present, the concentration of reducing agent may be in a range of about 200-500 mM.

The reducing agent is reactive with the free radical species, which augments the photoinitiator so that photoinitiation of the polymerization reaction occurs sooner and there is a better use of the photoinitiator in the polymerization. Thus, the reducing agent shortens the delay in photoinitiation while still permitting the polymerization to be non-linear with light dose. A shortened delay in photoinitiation of the polymerization permits 3D printing in larger volumes of photoresin formulation and increases the fidelity of the printed object. Without being held to any particular mechanism of action, the augmentation of the photoinitiator by the reducing agent is thought to be due to an amplification of the number of reactive free radical species that are available for photoinitiation by revitalizing the photoinitiator as the reducing agent reacts with the free radical species formed by the action of the photoinitiator on the polymerization inhibitor in the photoresin formulation. Scheme 1 illustrates a proposed mechanism with reference to molecular oxygen (O₂) as the polymerization inhibitor.

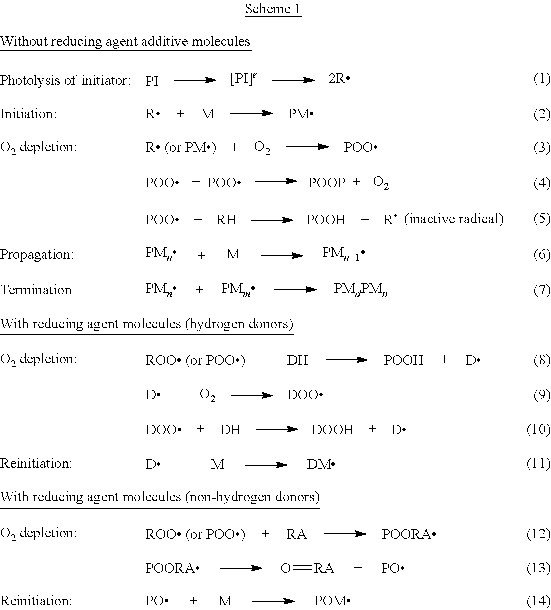

The photoinitiator (PI) decomposes into reactive radicals (R•). Molecular oxygen has a high reactivity towards radicals and will inhibit the initiation of polymerization by reacting with a photo-generated radicals to form alkylperoxyl radicals (POO•). In the absence of reducing agent, the alkylperoxyl radicals (POO•) terminate by recombining (reaction 4) or by hydrogen abstraction to form a stable radical that is not sufficiently reactive to initiate polymerization (reaction 5). Reactions 1-5 will continue until oxygen is almost completely consumed at which point the photo-generated radicals will react with monomer (M) or polymer (P) and trigger a chain reaction (reaction 6) until the polymer chains terminate (reaction 7). In contrast, reducing agent (DH) reacts with peroxyl radical (ROO• or POO•) but produces radicals that can react with a second oxygen molecule (reaction 9). The alkylperoxyl radical (DOO•) can subsequently react with another reducing agent (DH) (reaction 10) thereby regenerating the new reactive radical (D•). A reducing agent without hydrogen (DA) can also react with a peroxyl radical (ROO• or POO•) to produce unreactive radicals that decompose to a new reactive radical (PO•) (reaction 13). The new reactive radicals (D• and PO•) from both types of reducing agents amplify the number of oxygen molecules that are reduced by a photo-generated radical. Once the level of oxygen is below a certain concentration, the radical (D• or PO•) of the reducing agent will react with an acrylate and trigger polymerization (reaction 11 or 14).

The photoresin formulation may further comprise a solvent, for example an organic solvent, such as a non-polar organic solvent. Some specific examples of solvents include toluene, heptane, n-octane, tetrahydrofuran, ethanol, isopropanol, or any mixture thereof. In some embodiments, the solvent comprises toluene, heptane, n-octane or any mixture thereof. A solvent may be used to adjust the viscosity of the photoresin formulation and/or to more homogeneously disperse one or more of the other components throughout the photoresin formulation.

The monomer together with any solvent make up the bulk of the mass of the photoresin formulation. In some embodiments, the amount of solvent comprises no more than 50 wt % of the photoresin formulation based on the combined weight of monomer and solvent. In other embodiments, when a solvent is present in the photoresin formulation, the amount of solvent comprises 1-25 wt % or 1-15 wt %, based on the combined weight of the monomer and solvent.

### Process:

While the photoresin formulations are useful in any 3D printing process for producing a printed object, the photoresin formulations are particularly useful in volumetric additive manufacturing processes. Volumetric additive manufacturing (VAM) is a 3D printing technology that uses photoresin formulations to fabricate complex 3D objects at once while reducing or eliminating the need for support structures. Tomographic 3D printing and computed axial lithography (CAL) are types of VAM. The VAM technique is very fast and yields smoother objects with no layers and fewer surface artifacts than other volumetric techniques such as stereolithography (SLA) and digital light processing (DLP). Further, VAM permits printing around an existing object (overprinting).

VAM involves obtaining patterned light images of an object through the reverse of computed tomography (CT) and projecting the patterned light images towards a container, preferably a rotating container, filled with the photoresin formulation. Patterns are calculated so that the shape of the light dose distribution matches the object to be printed. When the photoresin formulation locally absorbs light doses exceeding a ‘gelation threshold’, the photoresin formulation solidifies to form the desired 3D object. In other words, when and where the local light dose exceeds the polymerization threshold, the object cures, while the rest of the print volume remains liquid.

The ‘gelation threshold’ in polymerization may be achieved by using a polymerization inhibitor that inhibits polymerization until the polymerization inhibitor is depleted. For example, the use of oxygen (O₂) as the polymerization inhibitor prevents the polymerization of acrylates until most of the oxygen is consumed through the reaction with photo-generated photoinitiator radicals. The ‘gelation threshold’ provides for a delay time for the photoinitiated polymerization reaction, after which the polymerization proceeds at a rate that is a non-linear with light dose. While a delay time is desirable to provide a polymerization reaction that proceeds at a rate that is a non-linear with light dose, the delay time increases the overall printing time, which is undesirable.

Traditional VAM suffers from several problems that limit the potential applications for VAM, as follows:

The photoresin formulation must have sufficiently high viscosity to minimize sedimentation of solidified resin, to prevent flow of resin that can lead to undesirable printing artefacts and to reduce diffusion of reactive species (e.g., the polymerization inhibitor, the photoinitiator). However, most commercial acrylates have low viscosities (below 100 cP) and the few options of acrylates that have sufficient viscosities for traditional VAM printing limit the material properties that can be achieved. In addition, high viscosity resins are more difficult and time consuming to process when compared to using low viscosity resins. Moreover, at very high viscosity, the photopolymerization rate can be limited due to the constrained movement of molecules, and this may lead to slow printing time and poor printing fidelity.

The photoresin formulation should allow sufficient light to penetrate through the print volume of the photoresin formulation to ensure that photopolymerization can be initiated in all regions of the print volume at substantially the same time. Traditionally, this can be accomplished by reducing the concentration of the photoinitiator, which is responsible for a majority of the light absorption, but reducing photoinitiator concentration increases printing time, which is undesirable for overall printing efficiency and increases the likelihood of sedimentation of solidified resin, flow of resin, and diffusion of reactive species. Generally, long printing time exacerbates: photoresin formulation component flow due to diffusion, vial rotation and convection from heat generated by the polymerization reaction negatively impacting fidelity and resolution of the printed object; polymerization inhibitor (e.g., oxygen) diffusion between the print volume and the rest of the photoresin formulation negatively impacting resolution and surface finish of the printed object; and, sedimentation of the polymerized part during the process negatively impacting fidelity, resolution and surface finish of the printed object.

The photoresin formulation must also have an underlying mechanism that causes the polymerization to be non-linear with light dose. Therefore, the presence of a polymerization inhibitor to provide threshold behavior (i.e., a delay time) for photopolymerization is important. However, the delay time increases printing time, which as discussed above is undesirable for overall printing efficiency and increases the likelihood of sedimentation of solidified resin, flow of resin and diffusion of reactive species. Printing time can be decreased by increasing the light intensity; however, the projector used in volumetric printing imposes an upper limit on light intensity. Printing time can also be decreased by increasing photoinitiator concentration, but increased photoinitiator concentration exacerbates the problem of sufficient light penetration into the print volume.

Thus, the following parameters of the printing process and the printed object are affected by one or more of the problems faced in VAM: printing time (i.e., how much time is required to print an object, which also exacerbates problems with the parameters below); print fidelity (i.e., how closely the printed part resembles the intended design); print resolution (i.e., the smallest feature size that is printable); and surface finish (e.g., degree of smoothness, degree of tackiness). To mitigate these issues, several strategies are employed herein.

The viscosity of the photoresin formulation contributes to both fidelity and resolution, and affects printing speed and time to print various sizes of features. The photoresin formulations can be formulated with relatively low viscosity making the formulations easier to prepare and post-process, thereby increasing the efficiency of the overall printing process.

Reactivity of the monomers affects printing speed; therefore, mixtures of monomers can be used and the concentration of the more reactive monomers can be controlled to increase printing speed thereby reducing printing time.

The presence of the reducing agent in the photoresin formulation permits control over the reactivity of the polymerization inhibitor allowing the polymerization inhibitor to react with the photo-generated photoinitiator radicals while permitting the polymerization reaction to proceed sooner, i.e., with less delay time, while still permitting polymerization to be non-linear with light dose. With the reducing agent present in the photoresin formulation, the duration of time to produce the printed object can be reduced by at least 50-99%, for example 70-95%, in comparison to a duration of time to produce an object from a photoresin formulation lacking the reducing agent but which is otherwise the same as the photoresin formulation. Because the delay time is shorter, a higher viscosity photoresin formulation is not as important to prevent sedimentation, component flow and polymerization inhibitor diffusion, permitting the use of lower viscosity photoresin formulations that can employ a wider variety of monomers while retaining very good print fidelity and resolution. Being able to use lower viscosity photoresin formulations further reduces the print time required to form objects with high fidelity and resolution. Low viscosity photoresin formulations take less time to prepare and post-process, increasing the efficiency of the overall printing process.

The diffusion of polymerization inhibitor (e.g., oxygen) between the print volume and the rest of the photoresin formulation introduces systemic differences in print time between large and small features. The difference in print time occurs as the result of the polymerization inhibitor diffusing back into the print volume before the object solidified thereby delaying the onset of polymerization. If feature sizes are below the length scale that the polymerization inhibitor can diffuse during the time frame required to trigger polymerization, these features will fail to print. Therefore, the smaller features require higher dose to trigger polymerization and form a solid polymer. When this difference is not corrected for, print geometries that possess a broad range of feature sizes will have over-printed large features due to over exposure or under-printed (or print failure of) fine features due to under exposure. Though it is possible to partially correct for this printing artefact using computational methods, it is not convenient as the polymerization inhibitor diffusion, sedimentation and flow effects are unique to each resin. The diffusion of the polymerization inhibitor in and out of the print volume also leads to a lower polymer conversion in the outer layer of the printed object and will cause the surface of the object to be tacky. The reducing agent reduces the amount of the polymerization inhibitor that diffuses back into the print volume, thereby mitigating this problem resulting in printed objects having better fidelity, resolution and surface finish.

Thus, the reducing agent both lowers the amount of photoinitiator required to print and decreases the time required to reach gelation (i.e., reduced delay time). Therefore, printing time is reduced and the effects of sedimentation, resin flow and reactive species diffusion are reduced resulting in improved print fidelity, print resolution and surface quality of the printed object.

In general, depending on printing conditions (e.g., projector wavelength, light intensity, printing vial size, and the like) and the desired material properties, the photoresin formulation can be finely tuned by selecting appropriate components at appropriate concentrations to provide a formulation having target viscosity and other characteristics. Printing speeds using the photoresin formulation can be very fast, for example 1 minute or less, even 30 seconds or less. Objects printed from the photoresin formulation can be very smooth, with root mean square (RMS) surface roughness of less than 20 nm being achievable for micro prints. RMS error of 0.2 mm or less, even 0.15 mm, and even as low as 0.1 mm can be achieved. Smaller objects and objects with fine detail can be printed with higher fidelity and resolution. The minimum printable box dimension can be 14 mm or less.

In some embodiments, the photoresin formulation has a viscosity in a range of 50-100,000 cP, or 50-50,000 cP, or 50-10,000 cP. In some embodiments, the projector wavelength is in a range of about 350-800 nm, while in other embodiments 350-495 nm. In some embodiments, the projected light has an average pixel intensity in a range of about 5-45 mW/cm², while in other embodiments 0.1-50 mW/cm². The average pixel intensity is the sum of the light intensity for each pixel divided by the number of pixels, within the illuminated area. In some embodiment, the vial size is in a range of about 0.3-30 cm in diameter, while in other embodiments 0.6-15 cm. In some embodiments, the photoresin formulation can provide particularly fast printing speed by simultaneously fine-tuning reactivity (with the presence and concentration of the reducing agent, the concentration of the photoinitiator and the concentration of more reactive monomer resins) and viscosity (in a relatively low viscosity range of about 50-10,000 cP) during VAM printing using light having an average pixel intensity in a range of about 5-45 mW/cm².

### EXAMPLES

### Materials and Methods

### Materials

### Photocurable Monomer Resins:

diurethane dimethacrylate (DUDMA, about 8,000-10,000 cp, Esstech Inc.);
bisphenol A glycidyl methacrylate (BisGMA, about 680,000 cp, Esstech Inc.);
bisphenol A glycerolate (1-glycerol/phenol) diacrylate (BPAGDA);
poly(ethylene glycol) diacrylate (PEGDA, Mn=250, 575 or 700 g/mol, Sigma-Aldrich);
hexyl acrylate (HA);
2-[[butylamino)carbonyl]oxy]ethyl acrylate (BCOEA).

### Photoinitiators:

ethyl (2,4,6-trimethylbenzoyl)phenyl phosphinate (TPO-L);
camphorquinone (CQ, Sigma-Aldrich);
ethyl 4-dimethylaminobenzoate (EDAB, Sigma-Aldrich).

### Reducing Agents:

N-methyldiethanolamine (MDEA, Sigma-Aldrich);
N,N-dimethylethanolamine (DMEA, Sigma-Aldrich);
ethyl diphenylphosphinite (EDPP, Sigma-Aldrich);
2-mercaptoethanol (ME, Sigma-Aldrich).

### Solvents:

toluene (Sigma-Aldrich)

### Photoresin Preparation

All components listed above were used as is. A two-component mixture of photocurable monomer resins was prepared by mixing the components in a vial. To this two-component mixture, the photoinitiator was added. Where two photoinitiators were used, a two-component photoinitiator system was first prepared and then added to the two-component mixture. The concentration of the photoinitiators was adjusted such that the penetration depth of the photoresin formulation was in-line with the radius of the vial. The photoresin formulation was mixed using a plenary mixer at 2,000 rpm for 15 min followed by 2,200 rpm for 30 sec, then separated into 20 mL scintillation vials (filled to about 15 mL). The photoresin formulation was kept in the dark in a fridge at 4° C. for storage.

The refractive index of the photoresin formulations were measured using a Schmidt-Haensch ATR-P refractometer. A TA Instruments Discovery Hybrid Rheometer 2 with UV light guide accessory was used for the photo-rheology test. The UV light source was EXFO Omicure™ S2000, which provides a broad range spectrum (220 nm to 600 nm). A 405 nm filter was used to adjust the wavelength of light source. Light source was calibrated using a THORLABS PM100D radiometer once the 405 nm filter was installed. A 20 mm disposable aluminum plate was used as the top geometry and a 20 mm disposable acrylic plate was used as the bottom geometry for all tests. The gap between the top and bottom geometry was maintained at 500 μm while the normal force was set to 0±0.1 N. All the curing experiments were performed at 0.3% strain and 0.5 Hz to ensure a high signal-to-noise ratio and it's within linear viscoelastic region at all times. Light intensity was kept at 5 mW/cm². In addition, all samples were pre-measured for 30 s before the UV light was turned on. All tests were conducted at room temperature.

### Printing

Before printing, photoresin formulations were decanted into open top glass vials used for printing (nominal diameter 25 mm, measured diameter 24.8 mm, Kimble) and allowed to warm to room temperature. If any residual bubbles remained, the resin formulation was left to sit until the bubbles had disappeared.

Photoresin-filled vials were centered on a rotation stage (Physik Instrumente M-060.PD) with a custom designed vial holder. The position of the vial in the field of view of the projector was measured by sweeping a vertical line horizontally across the projector field and capturing the photoinitiator fluorescence with the camera. This alignment step is only completed once and does not need to be updated unless the system comes out of alignment.

Projections are calculated and resampled according to the method described in Orth A, et al. On-the-fly 3D metrology of volumetric additive manufacturing. Feb. 7, 2022. D01:10.1016/j.addma.2022.102869 (https://arxiv.org/abs/2202.04644), the entire contents of which is herein incorporated by reference.

Micro prints were created with a digital light innovations CEL5500 light engine, with a 405 nm LED source. The projection lens was replaced with two 75 mm focal length, plano-convex lenses (Thorlabs #LA1608) and an adjustable iris in a 4F arrangement, resulting in a telecentric projected image with pixel size of about 10.8 μm. At the projector focus distance was located an 8 mm outer-diameter vial mounted to the rotation stage (PI Instruments). Rotation rates are adjustable but are normally set at 60 degrees/second. An optical scattering tomography (OST) system was implemented, with a red LED source mounted vertically above the vial, and a FLIR camera mounted perpendicular to both the projector and LED light. All prints were performed at room temperature, with typical projector irradiance values of 7 to 10 mW/cm².

### Post-Processing

Finished prints were removed from the vial with a metal spatula and placed immediately in a dish filled with isopropyl alcohol (IPA, Sigma-Aldrich). The print was left to soak in IPA for a selected period of time (usually 10-20 minutes but depending on the photoresin formulation and print size) and then removed and left to dry at room temperature. Prints were subsequently post-cured using 405 nm light for a selected period of time at selected temperature (e.g., 120 minutes at 60° C.) in a Formlabs Form Cure.

### Example 1: Effect of Viscosity on Printing

To determine the effect of viscosity on printing, photoresin formulations without reducing agent were prepared as described above in accordance with the formulations in Table 1.

TABLE 1

| | Acrylate | Acrylate | | | Viscosity |
|---|---|---|---|---|---|
| Sample | Monomer 1 | Monomer 2 | Solvent | Photoinitiator | (cP) |
| 1 | 80 g | 20 g | — | 0.05 g TPO-L | 2,040 |
| DUDMA/PEGDA | DUDMA | PEGDA | | | |
| 700 | | (700 g/mol) | | | |
| D8P2 | | | | | |
| 2 | 70 g | 30 g | — | 0.12 g CQ | 1,150 |
| DUDMA/PEGDA | DUDMA | PEGDA | | 0.12 g EDAB | |
| 700 | | (700 g/mol) | | | |
| D7P3 | | | | | |
| 3 | 95 g | — | 5 g | 0.05 g TPO-L | 2,670 |
| D95T5 | DUDMA | | Toluene | | |
| 4 | 90 g | 10 g HA | — | 0.05 g TPO-L | 1,560 |
| DUDMA/HA | DUDMA | | | | |
| 5 | 80 g | 20 g | — | 0.05 g TPO-L | 9,500 |
| DUDMA/BCOEA | DUDMA | BCOEA | | | |
| 6 | 87.25 g | — | 12.75 g | 0.04 g TPO-L | 5,000 |
| BisGMA/Toluene | BisGMA | | Toluene | | |
| 7 | 75 wt % | 25 wt % | — | 0.12 g CQ | 5,836 |
| BPAGDA/PEGDA | BPAGDA | PEGDA | | 0.12 g EDAB | |
| 250 | | 250 | | | |

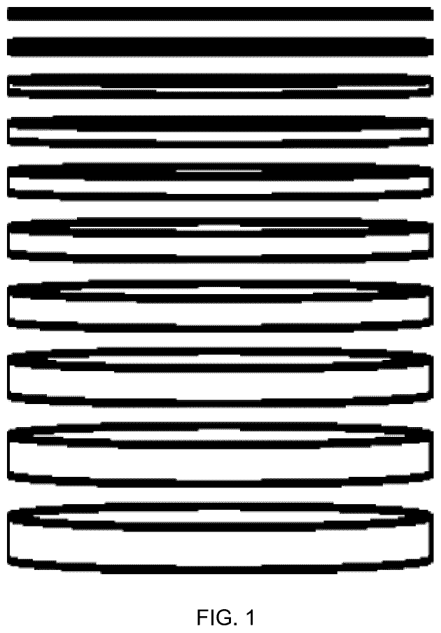

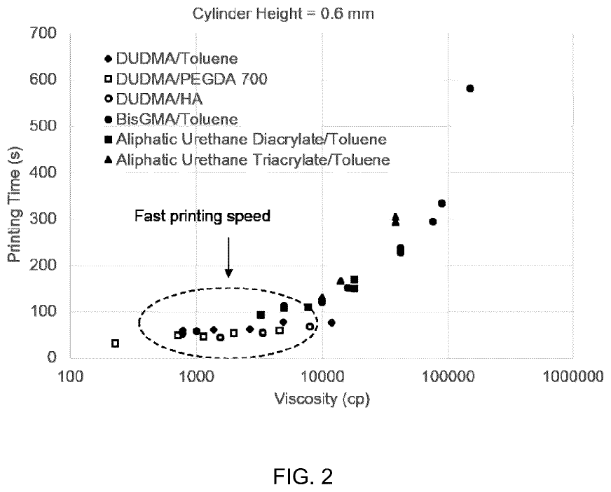

To determine how viscosity affects printing time, a test pattern was designed with a stack of cylinders of 10 mm diameter and heights ranging from 0.06 mm to 0.60 mm (see FIG. 1) to measure the time needed to print various feature sizes for photoresin formulations with various viscosities. High viscosity photocurable acrylate monomer resins were diluted using a reactive low viscosity monomer resin or a solvent to obtain photoresin formulations with a range of viscosities but the same reactivity for a fair comparison. As shown in FIG. 2, high viscosity acrylate photoresin formulations (i.e., BisGMA (Sample 6) and DUDMA (Sample 1)) were diluted using toluene to reduce their viscosities. It was shown that in all these cases printing speed increases with the decrease of the viscosity, and more significant effect of viscosity on printing time was noticed at higher viscosity ranges (greater than about 10,000 cP). Moreover, it was noted that to achieve relatively faster printing speed, photoresin formulations are preferably in the relative low viscosity ranges (less than about 10,000 cP). Taking into consideration sedimentation which may occur at lower viscosities, viscosities higher than about 50 cP may be used based on the printing experiments conducted using lower viscosity photoresin formulations.

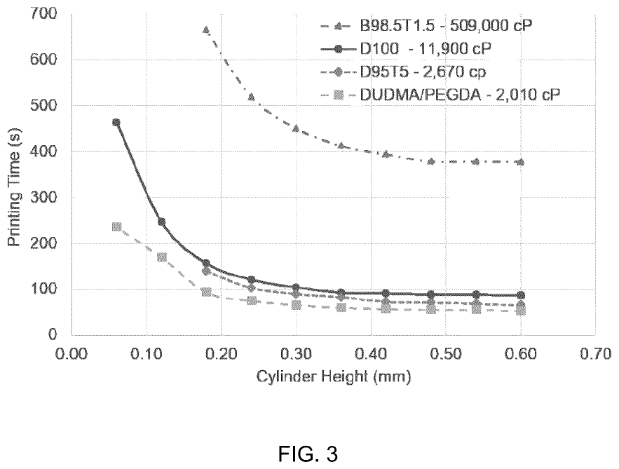

Furthermore, it was observed that viscosity also plays a role on printing quality. FIG. 3 shows that printing speeds may vary depending on the feature size (i.e., cylinder height), more specifically, smaller feature size prints (i.e., cylinders with heights less than about 0.24 mm) take significantly longer time to print. This difference in print time for different feature sizes leads to poor print fidelity (how closely the print dimensions match the digital copy). Thus, in order to achieve higher print quality, one may use a photoresin formulation with minimum printing time difference between the largest and smallest feature size. It was also noticed that, in some cases, for instance, photoresin formulation D95T5 (Sample 3, 2,670 cP) in FIG. 3, it was not possible to print thinner cylinders (i.e., cylinders with heights less than about 0.18 mm) in the tested printing conditions and therefore has poor print resolution. These results suggest that although choosing a photoresin formulation with suitable viscosity is important to yield a high-quality print, other parameters (e.g., reactivity of the monomer, initiator concentration, printing conditions, presence of a reducing agent, etc.) may contribute to print quality and should be considered when formulating photoresin formulations.

The printing tests also indicated that other than viscosity, reactivity of the photoresin also affects printing speed and quality. FIG. 3 further shows that at similar viscosities, printing speed can vary when using different reactive low viscosity monomer resins (i.e., DUDMA/PEGDA 700, DUDMA/HA) and high viscosity acrylate monomer resins (i.e., DUDMA/Toluene (D100), BisGMA/Toluene). Moreover, print quality can be improved by increasing reactivity of the photoresin formulation. For instance, thinner cylinders were not printable for photoresin D95T5 (Sample 3, 2,670 cP) (see FIG. 3). However, when PEGDA 700 (Sample 1) was used as a reactive low viscosity monomer resin, thinner cylinders were printed with the same printing conditions. Thus, it is important to consider both viscosity and reactivity of the photoresin to produce high quality prints at fast printing speed. Photoresin formulation reactivity can be adjusted by carefully choosing type and concentration of the reactive components (e.g., high and low viscosity acrylate monomer resins).

To determine the effect of viscosity on print quality, as well as preparation and post-processing, photoresin formulations without reducing agent were prepared as described above in accordance with the formulations in Table 2. As seen in Table 2, lower viscosity photoresin formulations tend to yield improved surface smoothness and reduced tackiness and requires significantly less time to prepare and post process.

TABLE 2

| | Low Viscosity Monomer | High Viscosity Monomer |
|---|---|---|
| | Resin | Resin |
| Resin Formulation | Sample 2 | Sample 7 |
| Photoinitiator | 7.8 mM CQ | 7.8 mM CQ |
| | and EDAB at 1:1 wt. ratio | and EDAB at 1:1 wt. ratio |
| Viscosity (cP) | 2,040 | 5,836 |
| Printing time (s) | 37 | 300 |
| Minimum RMSE error in | 0.102 | 0.158 |
| dimensional accuracy (mm) | | |
| Surface finish | Smooth | Rough and tacky |

### Example 2: Effect of Reducing Agent on Printing

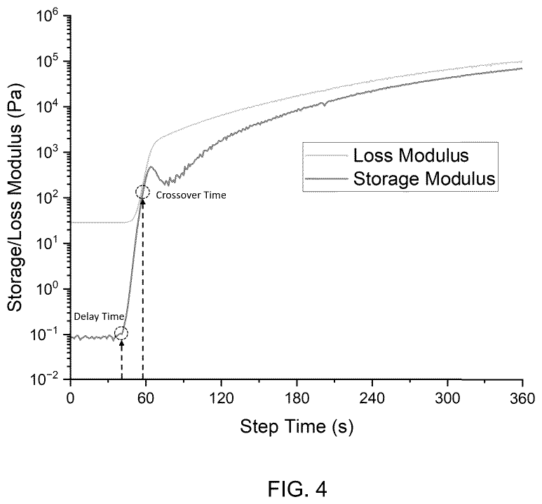

Delay and Cross-over Time from Photo-Rheology Measurements Photo-rheometry data can be used to characterize the threshold gelation of a photoresin formulation at a particular light intensity. A TA Instruments Discovery Hybrid Rheometer 2 with UV light guide accessory was used for the photo-rheology test. The UV light source was EXFO Omicure™ S2000, which provides a broad range spectrum (220 nm to 600 nm). A 405 nm filter (ThorLabs, FWHM 10 nm) was used to adjust the wavelength of light source. Light source was calibrated using a THORLABS PM100D radiometer once 405 nm filter was installed. A 20 mm disposable aluminum plate was used as the top geometry and a 20 mm disposable acrylic plate was used as the bottom geometry for all tests. The gap between the top and bottom geometry was maintained at 500 μm while the normal force was set to 0±0.1 N. All the curing experiments were performed at 0.3% strain and 0.5 Hz. Light intensity was kept at 5 mW/cm². In addition, all samples were pre-measured for 30 s before the UV light was turned on. All tests were conducted at room temperature. As seen in FIG. 4, loss and storage moduli remain unchanged during the oxygen depletion stage of printing using an acrylate-based photoresin formulation. Once oxygen is depleted, the storage and loss modulus increase, an indication that acrylates have begun to polymerize to form high molecular weight polymer chains (delay time). The gelation point of the polymer is defined as the time required for the storage modulus to exceed the loss modulus (i.e., the cross-over point). The time required to reach the cross-over point during printing is the cross-over time, which can be used as a proxy for measuring gelation time.

### Example 2A: Amine Reducing Agents

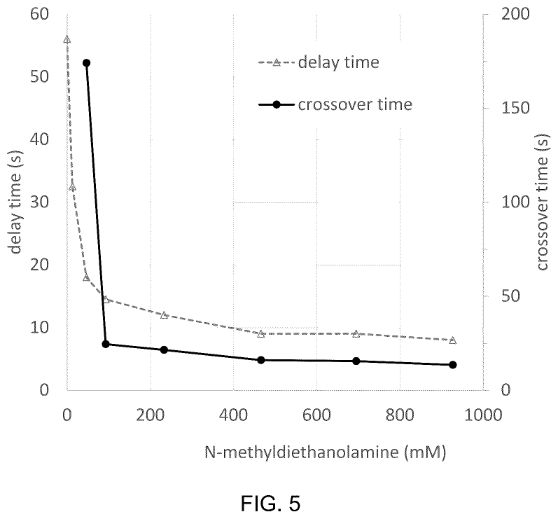

The cross-over and delay times for an acrylate-based photoresin formulation containing N-methyldiethanolamine (MDEA) as a reducing agent were investigated to illustrate that the cross-over time can be correlated to the delay time. Photoresin formulations containing 100 wt % DUDMA (acrylate-based monomer resin), based on total weight of acrylates in the formulation, and 1.75 mM TPO-L (photoinitiator) were mixed with various amounts of MDEA in a range of 0-970 mM. Photopolymerization was initiated with light having an average pixel intensity of 5 mW/cm². FIG. 5 shows a graph of delay time (s) and cross-over time (s) as a function of the concentration (mM) of MDEA. The results show that when no reducing agent is included, polymerization of the photoresin formulation begins after 56 seconds of exposure to 5 mW/cm² light (delay time). With the addition of 47 mM of MDEA, the photoresin formulation begins to polymerize after 18 seconds and will successfully gel into a polymer network after 147 seconds. With the addition of 466 mM MDEA, the delay and crossover time level off at about 9 seconds and 16 seconds, respectively, suggesting that higher concentrations of MDEA will not significantly decrease the print time or improve the print quality. It is evident from FIG. 5 that the delay time and the cross-over time follow very similar profiles over the concentration range. It is further evident that the addition of MDEA dramatically reduces both delay time and cross-over time. Further, the delay time and cross-over time plateau at about 100 mM MDEA.

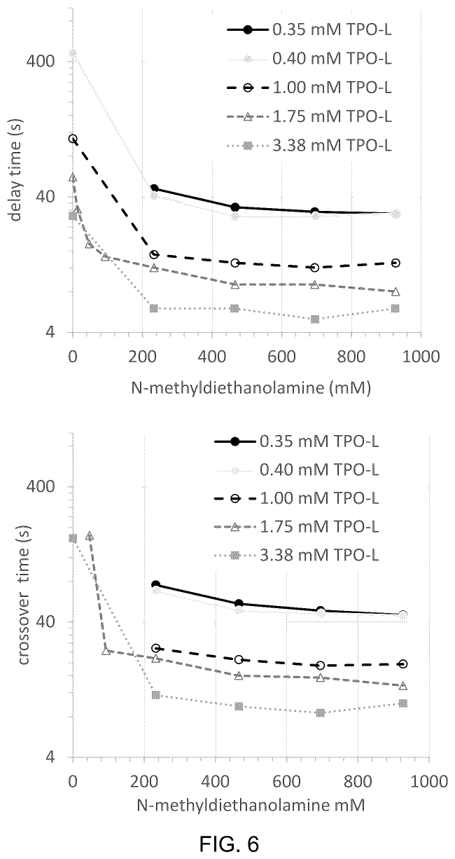

The delay times and cross-over times for 100 wt % DUDMA photoresin formulations as a function of MDEA (0-970 mM) for formulations containing various concentrations (0.35, 0.40, 1.00, 1.75 and 3.38 mM) of TPO-L photoinitiator are illustrated in FIG. 6. As seen in FIG. 6, increasing the photoinitiator concentration generally reduces the delay time and cross-over time. Further, at higher concentrations of photoinitiator, less reducing agent (MDEA) is required to lower the delay time and cross-over time. Alternatively, when less photoinitiator is desired, a higher concentration of reducing agent can be used to reduce delay time and cross-over time to a desirable level. For instance, at 0.35 mM TPO-L, the delay and crossover times for DUDMA containing 233 mM MDEA is 30 and 45 seconds, respectively. When the TPO-L concentration is 3.38 mM, the delay and crossover times is 6 and 10 seconds, respectively. FIG. 6 also shows that for all TPO-L concentrations tested, adding more than 233 mM MDEA does not significantly decrease the delay or crossover times. Ideally, photoresin formulations should be formulated with the highest amount of photoinitiator that the print volume will allow based on the penetration depth and with a concentration of reducing agents where the crossover points begins to level off.

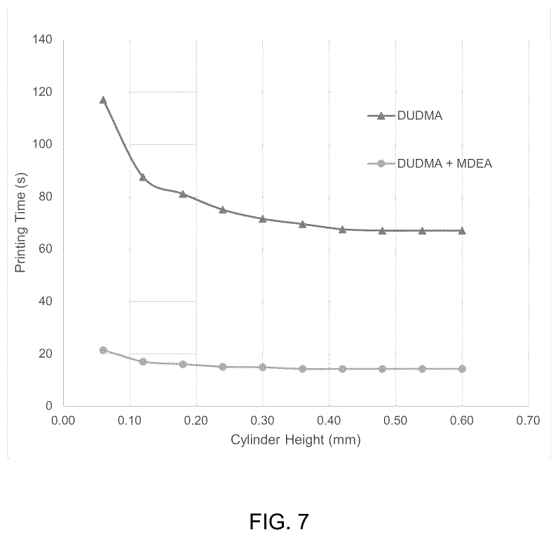

To demonstrate the improvement in print fidelity, a test pattern made up of a stack of cylinders with diameter of 10 mm and heights ranging from 0.06 mm to 0.60 mm were VAM printed. The time required for each cylinder to reach gelation (or print time), as determined by OST, was determined. Good print fidelity is achieved when the difference in print times among the cylinders of different sizes is minimized. FIG. 7 shows the print time of these cylinders using a standard VAM printer and DUDMA photoresin formulations with and without 466 mM MDEA. The results show that the resins containing MDEA print significantly faster than the resins containing no MDEA. For instance, a cylinder with a 0.06 mm height prints after 117 seconds in the photoresin formulation containing no MDEA and 21 seconds in the photoresin formulation containing 466 mM MDEA. In addition, the difference in print time among the cylinders is significantly less (a range of 14 to 21 seconds) for the photoresin formulations containing MDEA versus the control sample (67 to 117 seconds) for the cylinder heights studied. These results illustrate that it is possible to print objects with a broad range of feature sizes with good fidelity when MDEA is included in the formulation.

The influence of N-methyldiethanolamine (MDEA), in the photopolymerization of another acrylate-based photoresin formulation (D8P2) was investigated. D8P2 comprises 80 wt % DUDMA and 20 wt % PEGDA 700, weights based on total weight of the acrylates. The D8P2 formulations contained 1.75 mM TPO-L photoinitiator and concentrations of MDEA in a range of 0-970 mM. Table 3 shows the viscosities of the formulations at the various concentrations of MDEA.

TABLE 3

Average Viscosity (Pa · s)

| Conc. MDEA (nM) | DUDMA | D8P2 |
|---|---|---|
| 0 | 9.95 | 1.61 |
| 233 | 6.62 | 1.29 |
| 466 | 4.64 | 1.04 |
| 697 | 3.52 | 0.87 |
| 927 | 2.72 | 0.74 |

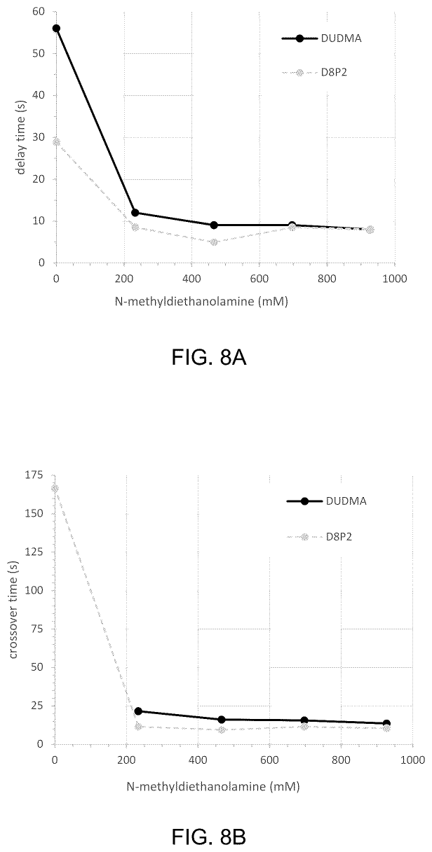

FIG. 8A shows a graph of delay time (s) as a function of MDEA concentration (mM), and FIG. 8B shows a graph of crossover time (s) as a function of MDEA concentration (mM), comparing the D8P2 formulations to the DUDMA formulations that contained the same concentrations of TPO-L and MDEA. The DUDMA formulation had a viscosity of 10,000 cp and the D8P2 formulation had a viscosity of 2,200 cP. The delay time and cross-over time are both lower in the low viscosity photoresin formulation (D8P2). Both photoresin formulations reach about the same cross-over time at about the same amount of added reducing agent (MDEA). The reduction in delay/crossover time is greater in the high viscosity formulation (DUDMA) due this formulation having a higher starting point. The optimal concentration (233 mM) of reducing agent (MDEA) is about the same for both photoresin formulations. Despite the differences in viscosities, the D8P2 photoresin behaves in a similar manner as DUDMA, with the delay time and crossover times leveling off at about 10 secs and about 12 secs respectively when 233 mM MDEA is added. This indicates that reducing agents can enable printing of both high and low viscosity photoresins, in particular, those that are difficult to print without a reducing agent.

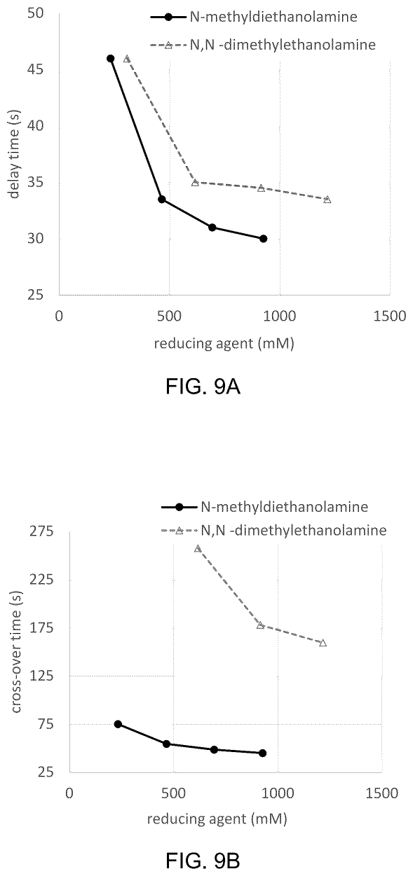

The effect of two different reducing agents, N-methyldiethanolamine (MDEA) and N,N-dimethylethanolamine (DMEA), on delay time and cross-over time on photopolymerization of the 100 wt % DUDMA photoresin formulation with 0.35 mM TPO-L photoinitiator was compared. The concentrations of the reducing agents were varied from 0-1200 mM and photopolymerization was initiated with light having an average pixel intensity of 5 mW/cm². FIG. 9A and FIG. 9B show that DMEA has a less dramatic effect on delay time and cross-over time than MDEA, but DMEA still lowers the delay and cross-over times until a plateau is reached at a certain concentration of the reducing agent.

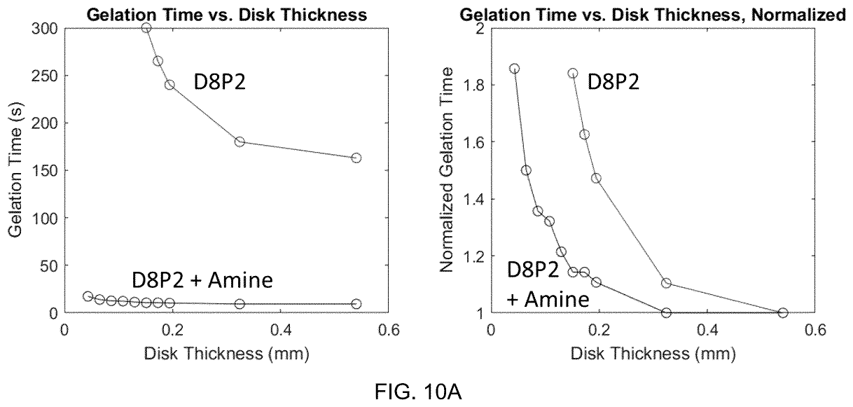

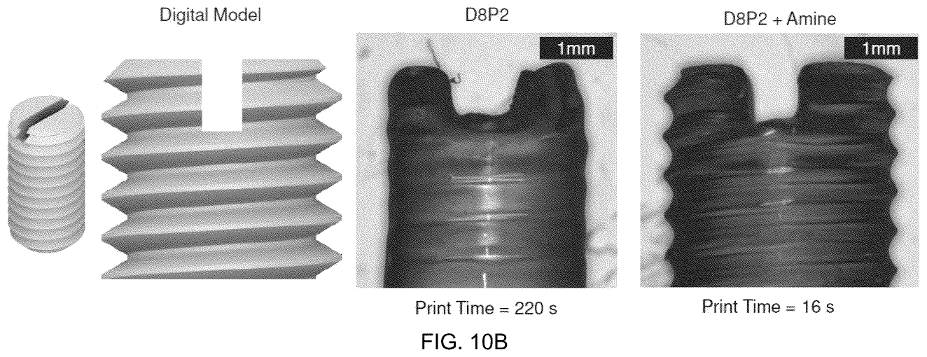

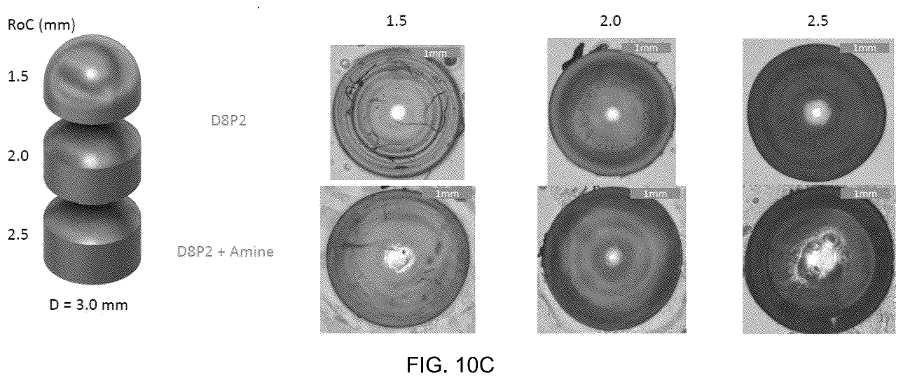

VAM printing using the D8P2 photoresin formulation comprising a mixture of 80 wt % DUDMA and 20 wt % PEGDA 700 (D8P2) with 1.75 mM TPO-L as the photoinitiator and a second formulation comprising the D8P2 photoresin formulation with 233 mM MDEA (D8P2+Amine) as a reducing agent were compared. Here, 3 mm outer diameter (OD) discs of various thicknesses were VAM printed from these photoresin formulations with a printer using radon projection, a rotation rate of 60 deg/s, an index of refraction of 1.51, a pixel size of 10.8 μm, a F # of 37.5 and white irradiance having an average pixel light intensity of 0.069 mW/mm². FIG. 10A shows gelation time (s) as a function of disc thickness (mm) (left graph) and normalized gelation time (s) as a function of disc thickness (mm) (right graph). It is evident from FIG. 10A that gelation time, which is about the same as printing time, is substantially reduced when MDEA is present. FIG. 10A also shows that printing speeds may vary depending on the feature size (i.e., cylinder height), more specifically, smaller feature size prints (i.e., cylinders with heights less than about 0.24 mm) take significantly longer time to print. This difference in print time for different feature sizes leads to poor print fidelity (how closely the print dimensions match the design model). Thus, in order to achieve higher print quality, one may use a photoresin formulation with minimum printing time difference between the largest and smallest feature size. With the addition of MDEA, the difference in gelation time (print time) significantly decreases for different disk heights. This can be more easily seen in the right panel in FIG. 10A where the gelation times normalized to the largest cylinder are plotted as a function of cylinder thickness. For cylinder heights less than 0.15 mm only the resin with MDEA formed cylinders. For cylinder heights less than 0.15 mm, normalized gelation times for the resin with MDEA stayed below 1.15 (i.e., the gelation time between cylinders of different heights varied by only 15%). However, for pure D8P2 the normalized gelation time reached a maximum of 1.84 indicating that the smallest cylinder takes almost twice as long to form as compared to the largest cylinder. These results demonstrate that the addition of MDEA allows for the retention of higher resolution features in printed parts, with minimal overexposure of larger features due to the smaller disparity in printing time between different feature sizes.

The two photoresin formulation were also used to print a model of a set screw as shown in FIG. 10B. It is evident from FIG. 10B that the photoresin formulation containing MDEA (D8P2+Amine) results in a printed set screw having greater print fidelity and better resolution at a shorter printing time than the photoresin formulation not containing MDEA (D8P2). The printing time for the D8P2+Amine was 16 s while the printing time for D8P2 was 220 s.

The D8P2 photoresin formulation with (D8P2+Amine) and without (D8P2) 233 mM MDEA as a reducing agent were used to print plano-convex lenses having different radii of curvature (RoC) as shown in FIG. 10C. The diameters of the lenses were the same at 3.0 mm and the nominal RoC's were 1.5 mm, 2.0 mm and 2.5 mm. For the lens with a nominal RoC of 1.5 mm, the lens printed with the D8P2 formulation had RoC of 1.56±0.10 and the lens printed with the D8P2+Amine formulation had RoC of 1.55±0.10. For the lens with a nominal RoC of 2.0 mm, the lens printed with the D8P2 formulation had RoC of 1.97±0.10 and the lens printed with the D8P2+Amine formulation had RoC of 2.00±0.10. For the lens with a nominal RoC of 2.5 mm, the lens printed with the D8P2 formulation had RoC of 3.16±0.25 and the lens printed with the D8P2+Amine formulation had RoC of 3.48±0.25. The RoC's were consistent between both formulations, and both formulations did well for the RoC 1.5 mm and 2.0 mm lenses.

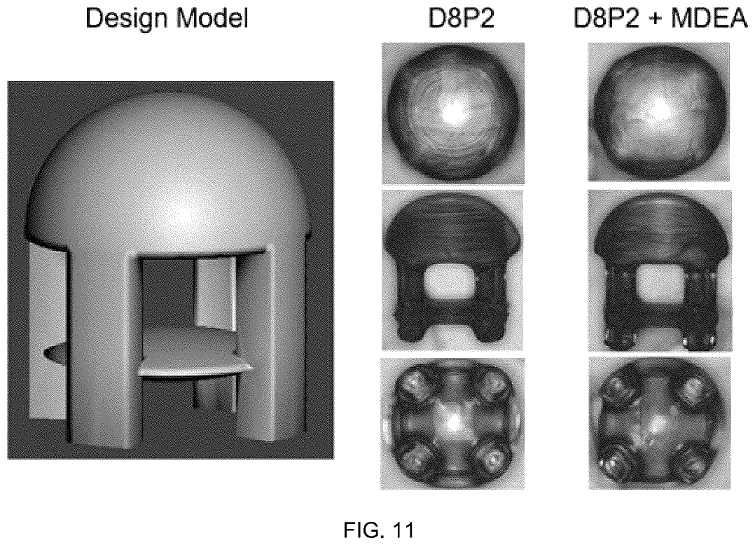

The D8P2 photoresin formulation with (D8P2+Amine) and without (D8P2) MDEA as a reducing agent were used to print a compound lens as shown in FIG. 11. FIG. 11 demonstrates two advantages of MDEA for the production of micro-optics, i.e., sharp feature retention and smooth surfaces. A compound lens design was created, where a plano-convex lens was connected to a smaller biconvex lens with four rectangular supports. In FIG. 11, microscope images of the compound lens printed without and with MDEA respectively are shown. The lens printed without MDEA exhibited striations (depicted as concentric lines) throughout the entire part and rounding of sharp edges. In contrast, the part made with MDEA did not exhibit any striations and retained many of the sharp features. This result demonstrates that MDEA has a practical benefit in the manufacturing of optical components, and any other components requiring high-resolution and a smooth surface finish.

### Example 2B: Other Reducing Agents

Table 4 compares the cross-over times for various photoresin formulations with different reducing agents, all of the formulations comprising 100 wt % DUDMA and 1.75 mM mM TPO-L. It is evident from Table 4 that all of the reducing agents dramatically reduce cross-over time. The organophosphorus reducing agents perform better than the amine and the thiol.

TABLE 4

| Reducing Agent | Cross-over Time (s) |
|---|---|
| none | 166 |
| 4.23 mM triphenylphosphine | 17.3 |
| 4.82 mM ethyl diphenylphosphinite | 17.2 |
| 121 mM ethyl diphenylphosphinite | 12.7 |
| 355 mM 2-mercaptoethanol | 35.4 |
| 233 mM MDEA | 21.5 |

The novel features will become apparent to those of skill in the art upon examination of the description. It should be understood, however, that the scope of the claims should not be limited by the embodiments but should be given the broadest interpretation consistent with the wording of the claims and the specification as a whole.

1. A photoresin formulation for volumetric additive manufacturing, the photoresin formulation comprising a photo-curable mixture of:
an acrylate-based monomer;
a photoinitiator;
a polymerization inhibitor comprising molecular oxygen (O₂); and,
a reducing agent reactive with a peroxyl radical formed from the polymerization inhibitor.

2. The formulation of claim 1, wherein the reducing agent comprises an amine, a thiol, a silane, a stannane, a phosphine, a phosphite, phosphinite, a phosphonate, an aldehyde, a borane or any mixture thereof.

3. The formulation of claim 1, wherein the reducing agent comprises 2-30 carbon atoms.

4. The formulation of claim 1, wherein the reducing agent comprises an organophosphorus compound.

5. The formulation of claim 1, wherein the reducing agent comprises N-methyldiethanolamine, N,N-dimethylethanolamine, 2-(N-methyl-N-phenylamino)-1-phenylethanol, dimethylamino ethylacrylate, alkyldimethylamine, N,N-bis[3-(methylamino)propyl]methylamine, N,N-dimethylaminobenzoate, N,N-dimethyl(2-morpholinoethyl)amine, 1,4-diazabicyclo[2.2.2]octane, tribenzyl amine, trimethylamine, tributylamine, pyrrolidine, ethylamine, piperazine, piperidine, 2-mercaptoethanol, pentaerythritol tetrakis(mercaptopropionate), 1,6-hexanedithiol, ethylene glycol bis(3-mercaptopropionate), mercaptopropylmethylsiloxane, mercaptobenzoxazole, mercaptobenzamidazole, mercaptobenzothiazole, trimethylolpropane tris(3-mercaptopropionate), tetrafluoroborate, dimethylamine-borane complex, dimethylaminopyridine borane complex, tert-butyl amine borane complex, morpholine borane complex, N-heterocyclic carbene borane complex, tris(trimethylsilyl)silane, triphenyl silane, ethyl diphenylphosphinite, methyl diphenylphosphinite, diethyl phosphonate, dioleyl hydrogen phosphite, dimethyl trimethylsilyl phosphite, tricyclohexylphosphine tributylphosphine triphenylphosphine, trimesitylphosphine, tris(2,4,6-trimethoxyphenyl)phosphine, triphenylphosphite, trioctyl phosphine, tetraphenyl dipropyleneglycol diphosphite, poly(dipropyleneglycol) phenyl phosphite, bisphenol A phosphite, tris(tridecyl) phosphite, triisopropyl phosphite, 3,9-bis(octadecyloxy)-2,4,8,10-tetraoxa-3,9-diphosphaspiro[5.5]undecane, tri-n-butyl stannane or any mixture thereof.

6. The formulation of claim 1, wherein the reducing agent comprises N-methyldiethanolamine, ethyl diphenylphosphinite or triphenylphosphine.

7. The formulation of claim 1, wherein the photoinitiator comprises: camphorquinone; ethyl 4-dimethylaminobenzoate; ethyl (2,4,6-trimethylbenzoyl) phenylphosphinate (TPO-L); 2-benzyl-2-dimethylamino-1-(4-morpholinophenyl)-butanone-1; 2-dimethylamino-2-(4-methyl-benzyl)-1-(4-morpholin-4-yl-phenyl)-butan-1-one; thioxanthone anthracene; diphenyl (2,4,6-trimethylbenzoyl) phosphine oxide; phenylbis(2,4,6-trimethylbenzoyl) phosphine oxide; sodium persulfate; 2-hydroxy-4′-(2-hydroxyethoxy)-2-methylpropiophenone or, any mixture thereof.

8. The formulation of claim 1, wherein the photoinitiator is present in the formulation in a concentration of 0.01-100 mM and the reducing agent is present in the formulation in a concentration of 1-500 mM.

9. The formulation of claim 1, wherein the monomer comprises a monoacrylate, diacrylate, a triacrylate, a tetraacrylate, a pentaacrylate, a monomethacrylate, a dimethacrylate, a trimethacrylate, a tetramethacrylate, a pentamethacrylate or any mixture thereof.

10. The formulation of claim 1, wherein the monomer comprises bisphenol A glycerolate (1 glycerol/phenol) diacrylate, an aliphatic urethane diacrylate, di-pentaerythritol pentaacrylate, a diurethane dimethacrylate (DUDMA), bisphenol A ethoxylate dimethacrylate, triethylene glycol dimethacrylate, bisphenol A-glycidyl dimethacrylate (BisGMA), gelatin methacrylate, poly(ethylene glycol) diacrylate, hexyl acrylate, 2-[[(butylamino)carbonyl]oxy]ethyl acrylate, trimethylolpropane triacrylate, ethoxylated bisphenol A dimethacrylate, tricyclodecane dimethanol diacrylate, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, or pentaerythritol tetraacrylate, 1,4-butanediol diacrylate or any mixture thereof.

11. The formulation of claim 1, wherein the photo-curable mixture further comprises an organic solvent.

12. The formulation of claim 11, wherein the organic solvent comprises toluene, heptane, n-octane, tetrahydrofuran, ethanol, isopropanol, or any mixture thereof.

13. The formulation of claim 1, wherein the photo-curable mixture has a viscosity in a range of 50-100,000 cP.

14. A volumetric additive manufacturing process for producing a printed object, the process comprising projecting patterned light for a duration of time through a print volume of the photoresin formulation as defined in claim 1.

15. The process of claim 14, wherein a pattern of the patterned light is calculated using tomographic imaging such that a shape of a light dose distribution matches the object to be printed.

16. The process of claim 14, wherein the print volume of the photoresin formulation is rotated during projection of the patterned light.

17. The process of claim 14, wherein the duration of time to produce the printed object is reduced by at least 50-99% in comparison to a duration of time to produce an object from a photoresin formulation lacking the reducing agent but which is otherwise the same as the photoresin formulation as defined in claim 1.

18. The process of claim 14, wherein the patterned light has an average pixel light intensity in a range of 0.1-50 mW/cm².

19. The process of claim 14, wherein the minimum printable box dimension is 14 mm or less.

20. A printed object produced by the process of claim 14.
